(19) United States
(12) Patent Application Publication
(10) Pub. No.: US 2021/0184221 A1
(43) Pub. Date: Jun. 17, 2021

(54) METAL-AIR BATTERY HAVING CATHODE PROTECTIVE LAYER AND METHOD OF MANUFACTURING THE METAL-AIR BATTERY

(71) Applicant: Samsung Electronics Co., Ltd., Suwon-si (KR)

(72) Inventors: Kyounghwan CHOI, Suwon-si (KR); Wonsung CHOI, Hwaseong-si (KR)

(21) Appl. No.: 17/093,768

(22) Filed: Nov. 10, 2020

(30) Foreign Application Priority Data
Dec. 13, 2019 (KR) 10-2019-0167140

(51) Int. Cl. H01M 4/86; H01M 12/08

(52) U.S. Cl. CPC H01M 4/8626; H01M 2004/8689; H01M 12/08; H01M 4/8663

(57) ABSTRACT

A metal-air battery includes: a cathode layer, an anode layer facing the cathode layer, a solid electrolyte layer disposed between the cathode layer and the anode layer, and an oxygen permeable protective layer on a surface of the cathode layer

### CROSS-REFERENCE TO RELATED APPLICATION

This application claims priority to and the benefit of Korean Patent Application No. 10-2019-0167140, filed on Dec. 13, 2019, in the Korean Intellectual Property Office, and all the benefits accruing therefrom under 35 U.S.C. § 119, the disclosure of which in its entirety is incorporated herein by reference.

### BACKGROUND

### 1. Field

The present disclosure relates to a rechargeable battery, and more particularly, to a metal-air battery including a cathode protective layer and a methods of manufacturing the metal-air battery.

### 2. Description of Related Art

Metal-air batteries, such as a lithium metal air battery have a high specific energy, may be used as an energy source for an electric vehicle. A lithium metal air battery including a solid electrolyte as an electrolyte, may operate under conditions in which ionic conductivity results in the generation of water or water vapor at a cathode.

### SUMMARY

According to an embodiment, provided is a metal-air battery, in which damage or deformation of a cathode caused by a reaction by-product generated during a charge and discharge process is reduced.

According to an embodiment, provided is a method of manufacturing the metal-air battery.

Additional aspects will be set forth in part in the description which follows and, in part, will be apparent from the description.

In accordance with an aspect of the disclosure, a metal-air battery includes: an anode layer, a cathode layer facing the anode layer; a solid electrolyte layer between the anode layer and the cathode layer; and an oxygen permeable protective layer on a surface of the cathode layer.

The entire surface of the cathode layer may be covered with the protective layer.

The metal-air battery may further include an anode electrolyte layer between the anode layer and the solid electrolyte layer.

A gas diffusion layer may further be provided on the protective layer.

The protective layer may include a first oxygen permeable protective layer on the entire surface of the cathode layer, and a second oxygen permeable protective layer on the first oxygen permeable protective layer.

The first oxygen permeable protective layer and the second oxygen permeable protective layer may have thicknesses different from each other.

The second protective layer may have an elongation which is greater than an elongation of the first protective layer.

The cathode layer may be a porous material layer including a plurality of particles.

The cathode layer may include an electron conductive material layer including carbon, a metal oxide, a metal, or a combination thereof.

The protective layer may be a material layer having an electrical conductivity of 1×10⁶ Siemens per centimeter to about 1×10⁸ Siemens per centimeter and an elongation of about 1% to about 50%.

The protective layer may have a thickness of about 1 nanometer (nm) to about 1,000 (nm).

The cathode layer includes a porous support including a plurality of pores through which oxygen permeates.

The oxygen permeable protective layer surrounds an outer surface of the porous support and is configured to suppress deformation of the cathode layer.

In accordance with an aspect of the disclosure, a method of manufacturing a metal-air battery includes: forming a cathode layer on a solid electrolyte layer; forming the oxygen permeable protective layer on the cathode layer; and forming the anode electrolyte layer on the solid electrolyte layer.

The method may further include attaching the anode layer to the solid electrolyte layer so that a bottom surface of the solid electrolyte layer contacts an upper surface of the anode layer.

The method may further include attaching a gas diffusion layer to the oxygen permeable protective layer.

The forming of the oxygen permeable protective layer may include forming a first oxygen permeable protective layer on an entire surface of the anode layer, and forming a second oxygen permeable protective layer on the first oxygen permeable protective layer. The first and second oxygen permeable protective layers may have an elongation different from each other.

The forming of the oxygen permeable protective layer may include a sputtering method, an atomic layer deposition method, or a combination thereof.

In accordance with an aspect of the disclosure, a method of manufacturing a metal-air battery includes: forming a cathode layer having a structure configured to suppress shape deformation on a solid electrolyte layer; forming an anode electrolyte layer on an anode layer facing the cathode layer; and attaching the anode electrolyte layer to the solid electrolyte layer so that the anode electrolyte layer contacts a bottom surface of the solid electrolyte layer.

The forming of the cathode layer may include: forming a porous support including a plurality of pores on the solid electrolyte layer; and forming an oxygen permeable protective layer on an outer surface of the porous support.

The forming of the oxygen permeable protective layer may include forming the protective layer to cover the entire outer surface of the porous support.

The oxygen permeable protective layer may include a metal having an electrical conductivity of about 1×10⁶ Siemens per centimeter to about 1×10⁸ Siemens per centimeter and an elongation of about 1% to about 50%.

The forming of the protective layer may include forming a first oxygen permeable protective layer on the entire outer surface of the porous support and forming a second oxygen permeable protective layer on the first protective layer.

In accordance with an aspect of the disclosure, a metal-air battery includes: an anode layer, a cathode layer, a solid electrolyte layer disposed between the anode layer and the cathode layer, and an oxygen permeable protective layer surrounding an outer surface of the porous support and configured to suppress shape deformation of the cathode layer, wherein the cathode layer comprises a porous support comprising a plurality of particles and a plurality of pores through which oxygen may permeate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an embodiment of a metal-air battery;

FIG. 2 is a cross-sectional view of an embodiment of a metal-air battery;

FIG. 3 is a graph of voltage (volts, V) versus capacity (milliampere hours, mAh) showing the results of charge and discharge tests of a metal-air battery according to an embodiment;

FIG. 4 is a graph of voltage (V) versus capacity (mAh) showing the results of charge and discharge tests a metal-air battery of the related art;

FIGS. 5A and 5B are scanning electron microscope (SEM) images of a cross-section of a control metal-air battery after a charge and discharge test;

FIGS. 6A and 6B are SEM images of a cross-section of a metal-air battery according to an embodiment, after a charge and discharge test; and

FIGS. 7 to 9 are cross-sectional views showing an embodiment of a method of manufacturing a metal-air battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As the charging and discharging processes of a metal-air battery are repeated, water is generated as a reaction by-product in a cathode layer. The water in pores of the cathode layer may expand as the charging and discharging processes are repeated. As a result, and while not wanting to be bound by theory, it is understood that particles constituting the cathode layer may be separated from each other, and thus, the cathode structure may collapse. As a result, a charge overvoltage may increase rapidly, and full charging may not be accomplished.

Accordingly, in order to increase a lifetime of the metal-air battery while ensuring the stability thereof, it would be beneficial to provide a method capable of suppressing or minimizing cathode expansion during charge and discharge.

A metal-air battery having a cathode structure capable of suppressing cathode expansion will be further described herein.

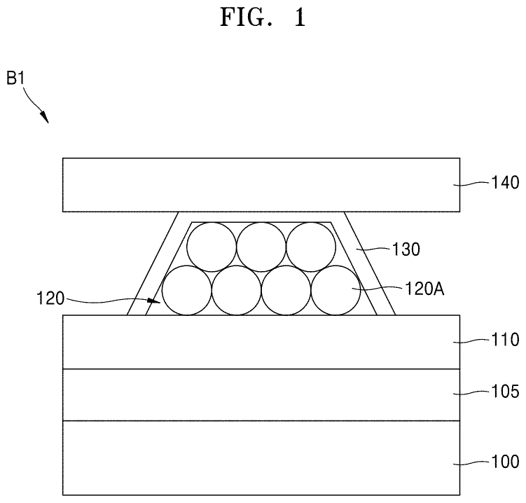

FIG. 1 is an illustration of a metal-air battery B1 (hereinafter, a first battery B1), according to an embodiment.

Referring to FIG. 1, the first battery B1 includes an anode layer 100, an anode electrolyte layer 105, a separator (solid electrolyte layer) 110, and a cathode layer 120, which are sequentially stacked. For example, the anode layer 100 may include a lithium (Li) layer, a zinc (Zn) layer, an aluminum (Al) layer, a magnesium (Mg) layer, or a combination thereof, but is not limited to these layers.

The anode electrolyte layer 105 and the separator 110 may facilitate a passage of ions between the cathode layer 120 and the anode layer 100. For example, the anode electrolyte layer 105 and the separator 110 may facilitate the movement of lithium ions from the anode layer 100 to the cathode layer 120. The anode electrolyte layer 105, in contact with the anode layer 100, may include an electrolyte, such as, a tetra (ethylene glycol) dimethyl ether (TEGDME) electrolyte.

The separator 110 functions as a solid electrolyte layer while simultaneously separating the cathode layer 120 from the anode layer 100. The separator 110 may be, for example, a Li₁₋ₓAlₓTi₂₋ₓ(PO₄)₃ (wherein 0≤x≤2) (LATP) solid electrolyte, but is not limited thereto. The cathode layer 120 may comprise, consist essentially of, or consist of a porous support including a plurality of pores through which oxygen may be introduced. For example, the cathode layer 120 may include a porous support including a plurality of particles 120A. Empty spaces, or pores, may be present between the plurality of particles 120A and may be defined by the plurality of particles 120A. Air (e.g., oxygen) may be introduced into the cathode layer through the empty spaces (pores).

The particles 120A in the porous support may comprise, consist essentially of, or consist of an electron conductive material such, as carbon, a metal oxide, a metal, or a combination thereof. As an example, the particles 120A may include a lithium lanthanum ruthenium oxide (LiLaRuO, LLRO), a lanthanum ruthenium oxide (LaRuO, LRO) particles, or a combination thereof. The particles 120A may comprise, consist essentially of, or consist of LLRO particles, LRO particles, or a combination thereof. The particles 120A may have a diameter of, for example, about 1 nanometer (nm) to about 300 nm, or about 1 nm to about 250 nm, or about 1 nm to about 100 nm. The diameter of the particles 120A may vary depending on the composition of the particles 120A.

The cathode layer 120 may be operated in a 100% relative humidity (RH) environment and provide ion conduction in the cathode layer 120. The particles 120A of the cathode layer 120 may be uniformly distributed over an entire upper surface of the separator 110, and the particles 120A may be in direct electrical contact with each other. Although the number of stacked layers of the particles 120A illustrated in FIG. 1 is two layers, this is for convenience of illustration, and the number of stacked layers of the particles 120A may be two or more layers.

An oxygen permeable protective layer 130 (also referred to herein interchangeably as “protective layer”) is disposed on the cathode layer 120, which is on the separator 110. In an example, the protective layer 130 may be on a portion of a surface of the cathode layer 120. In another example, the protective layer 130 may be on the entire upper surface of the cathode layer 120 so that the cathode layer 120 is not exposed. The protective layer 130 may provide an effect of suppressing shape deformation of the cathode layer 120. Accordingly, the protective layer 130 may have a structure configured to suppress shape deformation of the cathode layer.

The protective layer 130 has an oxygen transmission rate of about 1 cubic centimeter per square meter per day (cm³/m²/day) to about 2,000 cm³/m²/day, or about 10 cm³/m²/day to about 1,500 cm³/m²/day, or about 100 cm³/m²/day to about 1,000 cm³/m²/day, as measured at 23° C. and 0% relative humidity. The protective layer 130 may include a material that does not interfere with a charge and discharge reaction occurring in the cathode layer 120. The protective layer 130 may include a material having sufficient ductility to tolerate the expansion of the cathode layer 120 that may occur during a charge and discharge operation. Also, since an electron is transferred to the cathode layer 120 through the protective layer 130, the protective layer 130 may be a material layer having electrical conductivity or include such a material layer. A basic reaction by-product may be generated in the cathode layer 120 during a charging and discharging process, and thus, the protective layer 130 may be a material layer that may minimize a reaction with the basic reaction by-product (for example, LiOH when the anode layer 100 is a lithium layer) or may include such a material layer.

The protective layer 130 may include a material, for example a metal, having an electrical conductivity of about 1×10⁵ Siemens per centimeter (S/cm) to about 1×10⁹ S/cm, or about 5×10⁵ S/cm to about 5×10⁸ S/cm, or about 1×10⁶ S/cm to about 1×10⁸ S/cm. The material of the protective layer 130 may also be a ductile material having an elongation of about 1% to about 100%, about 1% to about 75%, or about 1% to about 50%, or about 3% to about 50%. In an embodiment, the protective layer 130 may include a metal. An example of a material having the above-described characteristic of the protective layer 130 may be include gold (Au), ruthenium (Ru), platinum (Pt), nickel (Ni), or a combination thereof. In particular, the protective layer may comprise, consist essentially of, or consist of a gold layer, a ruthenium layer, a platinum layer, or a combination thereof. These metal layers may be stable under oxidizing and basic conditions.

The protective layer 130 may have an oxygen transmission rate of about 1 cubic centimeter per square meter per day to about 2,000 cubic centimeters per square meter per day, when measured at 23° C. and at 0% relative humidity. The protective layer 130 may have a thickness through which air containing oxygen may pass. For example, the thickness of the protective layer 130 may be about 1 nm to about 1,000 nm, or about 5 nm to about 500 nm, or about 10 nm to about 100 nm. The thickness of the protective layer 130 may vary depending on the material used. For example, when the desired oxygen transmittance of the protective layer 130 is high, and when the protective layer 130 has the above-described characteristics, the thickness of the protective layer 130 may be as thick as possible within the above described thickness range. In the opposite case, when the desired oxygen transmittance of protective layer 130 is low, the thickness of the protective layer 130 may be as thin as possible within the above described thickness range.

The protective layer 130 may be formed using various methods, for example, a sputtering method, an atomic layer deposition method, or a combination thereof. A gas diffusion layer 140 may be disposed on the protective layer 130. Air may be evenly introduced into the cathode layer 120 through the gas diffusion layer 140.

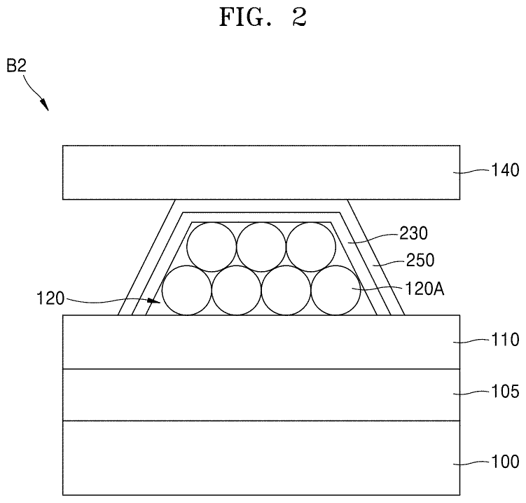

FIG. 2 is a cross-sectional view of a metal-air battery B2 (hereinafter, a second battery B2) according to another embodiment. Only those parts which differ from the first battery B1 of FIG. 1 will be described.

Referring to FIG. 2, the second battery B2 includes first oxygen permeable protective layer 230 and second oxygen permeable protective layer 250 (also referred to herein interchangeably as first and second protective layers) on the cathode layer 120. The first and second protective layers 230 and 250 are sequentially stacked on the cathode layer 120. As an example, the first protective layer 230 and the second protective layer 250 may be different material layers. The first protective layer 230 and the second protective layer 250 may each independently include a material having the above-described characteristics of the protective layer 130 of FIG. 1. A total combined thickness of the first and second protective layers 230 and 250 may be in a thickness range of the protective layer 130 of FIG. 1. In an example, the first and second protective layers 230 and 250 may have a same thickness. In another example, the first and second protective layers 230 and 250 may have thicknesses different from each other. The ductility (elongation) of the first and second protective layers 230 and 250 may be different from each other. As an example, the elongation of the second protective layer 250 may be greater than the elongation of the first protective layer 230. The first protective layer 230 and the second protective layer 250 may be independently, for example, an Au layer, a Ru layer, a Pt layer, a Ni layer, or a combination thereof.

Next, the capacity-voltage (CV) characteristics of a metal-air battery according to an embodiment is compared with a metal-air battery which does not include an oxygen permeable protective layer on a cathode layer.

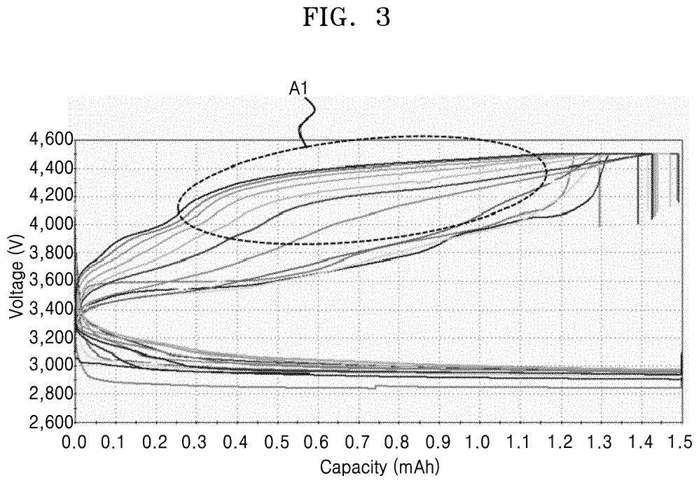

FIG. 3 is a graph showing the results of CV analysis of an embodiment of a metal-air battery.

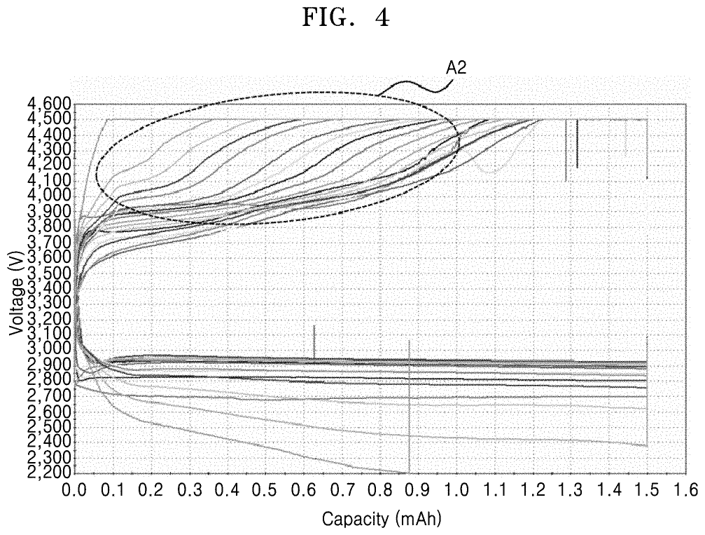

FIG. 4 is a graph showing the results of CV analysis of a metal-air battery of which does not include an oxygen permeable protective layer on a cathode layer (i.e., a comparative or control battery), for comparison with the metal-air battery according to an embodiment.

In a metal-air battery (hereinafter, an experimental example) used to measure the CV characteristics shown in FIG. 3, an LaRuO₃ was used as the material of the cathode layer 120 and an Au layer of 40 nm was formed on the cathode layer as the protective layer 130 (single layer). LATP, which is a solid electrolyte, was used as the separator 110, a lithium layer was used as the anode layer 100, and TEGDME was used as the anode electrolyte layer 105.

After forming the cathode layer 120, the formed cathode layer 120 was placed on the separator 110, and then the separator 110 and the cathode layer 120 were bonded together by heating the resultant product at a temperature of 350° C. Afterwards, an Au layer was formed on the bonded cathode layer 120, by sputtering Au on the surface of the bonded cathode layer 120. Thereafter, the anode electrolyte layer 105 was formed on the anode layer 100, and the resultant product was attached to the separator 110, such that the anode electrolyte layer 105 is in contact with the separation 110. The charge and discharge experiment was repeated about 22 times on the experimental battery.

A battery used to measure the CV characteristics of FIG. 4 (hereinafter, a control battery) was formed of the same material and according to the manufacturing process as the experimental battery, except that there is no protective layer. The charging and discharging experiment was repeated about 22 times on the control battery.

The charging and discharging experiment conditions of the control battery and the experimental battery were the same. The experimental conditions are as follows.

Experimental Condition

Current density: 0.3 mA/cm², cut-off voltage: 2.2-4.5V, mode: constant current-constant voltage (CCCV), charging and discharging at 3 mAh/cm² (corresponds to 0.1 C).

The C rate is a discharge rate of a cell, and is obtained by dividing a total capacity of the cell by a total discharge period of time, e.g., a C rate for a battery having a discharge capacity of 1.6 ampere-hours would be 1.6 amperes.

Referring to the CV characteristics of FIGS. 3 and 4, in the case of the experimental battery, as shown in FIG. 3, reversible charging and discharging is possible and the voltage is stably maintained during discharge. Also, it may be seen that the rise in the overvoltage is gradually decreased and stabilized during charge (refer to a first region A1). In the case of the control battery, as shown in FIG. 4, it may be seen that the overvoltage is suddenly increased during charge and discharge (refer to a second region A2), and the charge amount is continuously decreased.

Through comparison of FIGS. 3 and 4, it is apparent that the capacity-voltage (CV) characteristics of the experimental battery are superior to the CV characteristics of the control battery, and thus, it is obvious that the lifetime of the experimental battery is longer than that of the control battery under the same conditions.

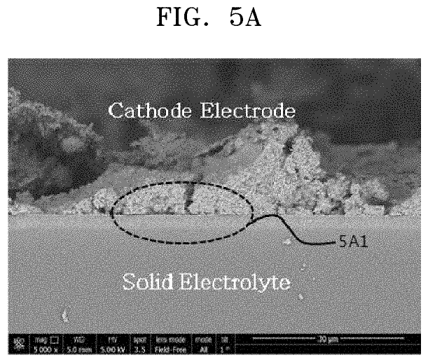

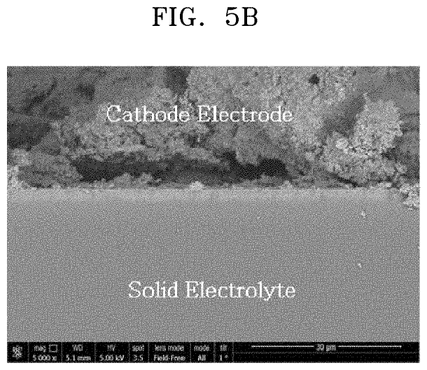

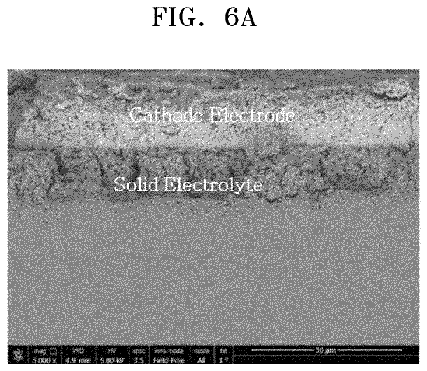

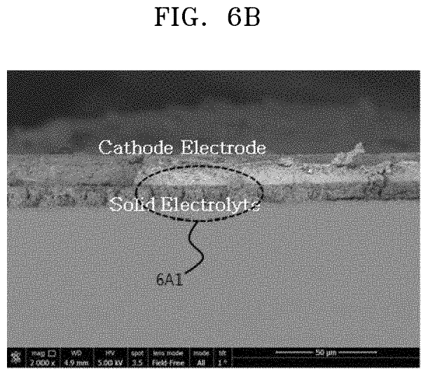

FIGS. 5A and 5B show the scanning electron microscope (SEM) images of cross-sections of the control battery and FIGS. 6A and 6B show the SEM images of cross-sections of the experimental battery, after the charging and discharging experiments are completed.

FIGS. 5A and 5B are SEM images of the control battery. FIG. 5B is an enlarged view of a first region 5A1 in FIG. 5A.

FIGS. 6A and 6B are SEM images of the experimental battery. FIG. 6A is an enlarged view of a first region 6A1 in FIG. 6B.

When FIGS. 5A and 5B are compared with FIGS. 6A and 6B, it can be seen that in the case of the control battery (FIGS. 5A, 5B), a gap is formed between a solid electrolyte and a cathode layer, and also, the cathode layer is broken.

On the other hand, in the case of the experimental battery (FIGS. 6A, 6B), it may be seen that a cathode layer is stably present on the solid electrolyte, and no gap is generated between the cathode layer and the solid electrolyte.

As a result, the damage to the cathode layer in the experimental battery is much less than the damage to the cathode layer of the control battery. Without being limited by theory, it is understood that this difference may indicate that the life of the experimental battery may be much greater than the life of the control battery.

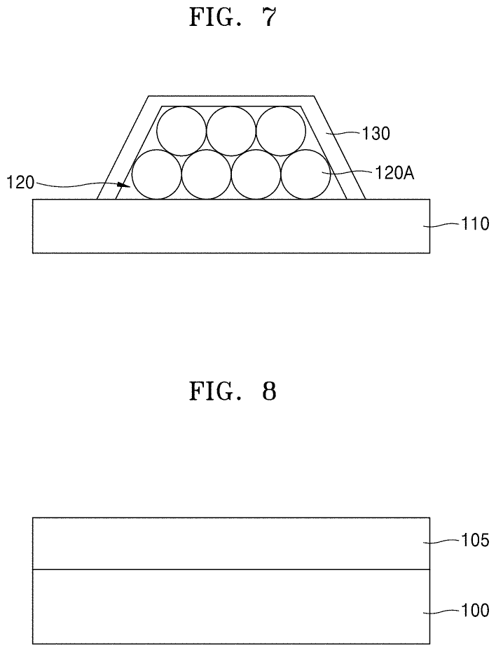

Next, a method of manufacturing a metal-air battery according to an embodiment will be described with reference to FIGS. 7 to 9. In the description, like reference numerals are used to indicate elements that are substantially identical to the elements of FIG. 1, and thus a description thereof will be omitted

First, as shown in FIG. 7, a cathode layer 120 is formed on a separator (solid electrolyte membrane) 110. The cathode layer 120 is covered with a protective layer 130. For example, the entire cathode layer 120 may be coated with the protective layer 130. The forming of the protective layer 130 on the cathode layer 120 may include a sputtering method, an atomic layer deposition (ALD) method, or a combination thereof.

In an example, a gold (Au) film as the protective layer 130 may be formed on the cathode layer 120. The Au film may be formed to a thickness of about 40 nm and may be formed by using a sputtering method. The Au deposition by the sputtering method may be performed at room temperature under an argon (Ar) gas atmosphere. That is, Ar may be used as a collision ion in the sputtering method. In the sputtering method, a power output may be maintained at about 40 milliamperes (mA) until the deposition is completed.

With regard to the material and thickness of the protective layer 130, the above-provided description is made with reference to FIG. 1 may be followed. Also, as shown in FIG. 2, the protective layer 130 may be formed as multiple layers by sequentially stacking the first protective layer 230 and the second protective layer 250.

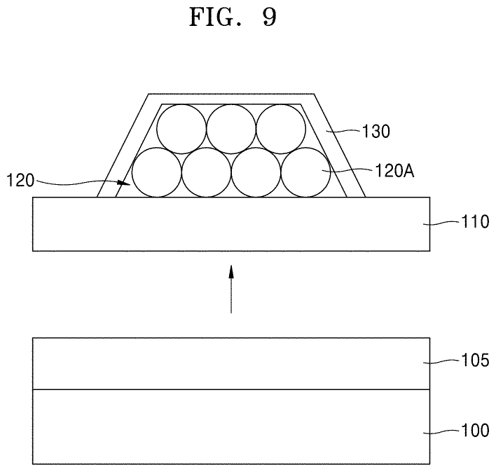

Next, as shown in FIG. 8, an anode electrolyte layer 105 is formed on the anode layer 100. Thereafter, as depicted in FIG. 9, the anode electrolyte layer 105 and the separator 110 are aligned to face each other, and then, an upper surface of the anode electrolyte layer 105 and a bottom surface of the separator 110 are contacted with each other. In this way, a metal-air battery according to an embodiment may be formed. After the upper surface of the anode electrolyte layer 105 and the bottom surface of the separator 110 are in contact with each other, a gas diffusion layer 140 may further be formed on the protective layer 130. The gas diffusion layer 140 may be formed separately, before the anode electrolyte layer 105 is contacted with the separator 110.

The disclosed metal-air battery includes an oxygen permeable protective layer disposed on and surrounding a cathode layer, which is disposed on a solid electrolyte. The protective layer covers at least a portion of the cathode layer. Accordingly, it is possible to suppress the expansion of the cathode layer as much as possible during charge and discharge of a metal-air battery and to suppress the separation of particles forming the cathode, thereby minimizing damage and deformation of the cathode. Accordingly, the charge and discharge characteristics of the battery may be improved, for example, a sudden increase in a charge overvoltage may be prevented during a charging process, and a full charge may also be possible.

It should be understood that embodiments described herein should be considered in a descriptive sense only and not for purposes of limitation. Descriptions of features, aspects, or advantages within each embodiment should be considered as available for other similar features, aspects, or advantages in other embodiments. While an embodiment has been described with reference to the figures, it will be understood by those of ordinary skill in the art that various changes in form and details may be made therein without departing from the spirit and scope as defined by the following claims.

What is claimed is:

1. A metal-air battery comprising:
an anode layer;
a cathode layer facing the anode layer;
a solid electrolyte layer between the anode layer and the cathode layer; and
an oxygen permeable protective layer on a surface of the cathode layer.

2. The metal-air battery of claim 1, wherein the oxygen permeable protective layer has an oxygen transmission rate of about 1 cubic centimeter per square meter per day to about 2,000 cubic centimeters per square meter per day, when measured at 23° C. and at 0% relative humidity.

3. The metal-air battery of claim 1, wherein the entire surface of the cathode layer is covered with the oxygen permeable protective layer.

4. The metal-air battery of claim 1, wherein the solid electrolyte layer is a separator, and the metal-air battery further comprises an anode electrolyte layer between the anode layer and the solid electrolyte layer.

5. The metal-air battery of claim 1, further comprising a gas diffusion layer on the protective layer.

6. The metal-air battery of claim 1, wherein the oxygen permeable protective layer comprises:
a first oxygen permeable protective layer on the entire surface of the cathode layer; and
a second oxygen permeable protective layer on the first oxygen permeable protective layer.

7. The metal-air battery of claim 6, wherein the first oxygen permeable protective layer and the second oxygen permeable protective layer have thicknesses different from each other.

8. The metal-air battery of claim 6, wherein the second oxygen permeable protective layer has an elongation which is greater than an elongation of the first oxygen permeable protective layer.

9. The metal-air battery of claim 1, wherein the cathode layer is a porous layer comprising a plurality of particles.

10. The metal-air battery of claim 1, wherein the cathode layer comprises an electron conductive material comprising carbon, a metal oxide, a metal, or a combination thereof.

11. The metal-air battery of claim 1, wherein the oxygen permeable protective layer comprises a metal having an electrical conductivity of about 1×10⁶ Siemens per centimeter to about 1×10⁸ Siemens per centimeter and an elongation of about 1% to about 100%.

12. The metal-air battery of claim 10, wherein the metal of the oxygen permeable protective layer is Au, Ru, Pt, Ni, or a combination thereof.

13. The metal-air battery of claim 1, wherein the oxygen permeable protective layer has a thickness of about 1 nanometer to about 1,000 nanometers.

14. The metal-air battery of claim 1, wherein the cathode layer comprises:
a porous support comprising a plurality of pores through which oxygen permeates; and a protective layer having oxygen permeability which surrounds an outer surface of the porous support to provide a structure that suppresses deformation of the cathode layer.

15. A method of manufacturing the metal-air battery according to claim 1, the method comprising:
forming the cathode layer on the solid electrolyte layer;
forming the oxygen permeable protective layer on the cathode layer;
forming the anode layer on the solid electrolyte layer to manufacture the metal-air battery.

16. The method of claim 15, wherein the forming of the oxygen permeable protective layer comprises forming a first oxygen permeable protective layer covering the entire surface of the cathode layer.

17. The method of claim 16, further comprising forming a second oxygen permeable protective layer on the first oxygen permeable protective layer.

18. The method of claim 15, wherein the forming of the oxygen permeable protective layer comprises a sputtering method, an atomic layer deposition method, or a combination thereof.

19. The method of claim 15, wherein the forming of the anode layer comprises attaching the anode layer to the solid electrolyte layer so that a bottom surface of the solid electrolyte layer contacts an upper surface of the anode layer.

20. The method of claim 15, further comprising forming an anode electrolyte layer on the anode layer, wherein the anode electrolyte layer is between the anode layer and the solid electrolyte layer.

21. A metal-air battery, comprising:
an anode layer;
a cathode layer;
a solid electrolyte layer disposed between the anode layer and the cathode layer; and
an oxygen permeable protective layer surrounding an outer surface of the cathode layer and configured to suppress shape deformation of the cathode layer,
wherein the cathode layer comprises a porous support comprising a plurality of particles and a plurality of pores through which oxygen may permeate.
